(19) United States
(12) Patent Application Publication
(10) Pub. No.: US 2024/0165573 A1
(43) Pub. Date: May 23, 2024

(54) REACTION VESSEL

(71) Applicant: Barton Blakeley Technologies Limited, Harpenden, Herts (GB)

(72) Inventor: Christopher Barton, Harpenden, Hertfordshire (GB)

(21) Appl. No.: 18/552,642

(22) PCT Filed: Mar. 29, 2022
(86) PCT No.: PCT/GB2022/050779

§ 371 Date: Sep. 26, 2023

(30) Foreign Application Priority Data
Mar. 29, 2021 (GB) 2104442.5

(51) Int. Cl. B01J 12/00; B01D 47/00; B01J 4/00; B01J 19/24; C01B 33/18; C09C 1/30

(52) U.S. Cl. CPC B01J 12/00; B01D 47/00; B01J 4/004; B01J 19/24; C01B 33/183; C09C 1/3081; B01J 2204/002; B01J 2219/1943; B01J 2219/1946

(57) ABSTRACT

A reaction vessel and method for producing functionalised Silica using a mixing chamber for mixing a silane and an oxide such as carbon dioxide provided using a delivery system to mix the gases so that they react to form functionalised Silica and other products such as Hydrogen and Carbon or other oxides.

### BACKGROUND OF THE INVENTION

Typically, exhaust gas from combustion and energy transformation processes, mainly for propulsion and energy generation, is released into the atmosphere and invariably contains various undesirable noxious air pollutants that causes adverse effects to the environment, on both a local and global scale. Oxides of carbon (COx), nitrogen (NOx) and sulphur (SOx) are all prime examples of the types of air pollutants found in exhaust gases from combustion and energy transformation processes.

Silica comes in various forms. Nano-Silica is a form of silica having extremely small particle size in the sub micrometre range. Whilst there are various forms of nano-silica including geological nano-silica, it is commonly formed synthetically. Synthetic Amorphous Silica (SAS) is a valuable form of silica, used in many applications such as filler additives for plastics, silicones, rubber, optics, high-performance concrete etc. Conventional methods for producing synthetic silica require high temperatures. Silica produced from such methods is typically not hydrophobic, and at least a further high temperature and/or pressure processing step is required in order to provide the Silica with hydrophobic properties. Hydrophobic properties are useful in Silica because Silica is commonly used as a primary or additive material in industries that can benefit from materials being made with or have a film of Silica, particularly nano-silica applied thereto to render the material hydrophobic, such as cements, glasses, screens and pharmaceutical & rheological processes etc.

Flame hydrolysis deposition is an example of a conventional method for producing Silica, which requires high temperature to produce Silica. This is typically achieved using a Hydrogen-Oxygen reaction. The use of these reactants means other reaction compounds introduced must be non-reactive with the initial Hydrogen-Oxygen mixture to prevent reactions occurring under the wrong conditions or prior to the introduction of these reactants into a reaction chamber. This process requires ignition, and nebulised silicon chloride to be present, which is costly and inconvenient. Further, hydrochloride gas is produced from this process, which is toxic and must be disposed of. In addition, to produce hydrophobic Silica, which has useful commercial properties, the Silica must be subsequently bake at high temperature along with a siloxane such as Polydimethylsiloxane. This is very energy intensive and requires the additional siloxane component making its production expensive.

The present invention aims to overcome or at least ameliorate one or more of the problems set out above.

### SUMMARY OF THE INVENTION

In a first aspect of the invention, there is provided a reaction vessel for producing functionalised Silica comprising: an enclosed mixing chamber for mixing silane gas and an oxide gas, a delivery system for delivering the silane and oxide to the mixing chamber to facilitate mixing of the silane and oxide within the mixing chamber; and one or more outlets through which the reaction products are removed from the reaction vessel.

Silica can be produced from a one-step reaction between the silane and the oxide. When carbon dioxide (CO₂) is used as the oxide, hydrophobic Silica is produced. Additionally, when calibrated accordingly, the reaction can produce high proportions of hydrogen which is useful as a fuel etc.

Preferably, at least one of the silane and oxide gas is charged. By providing a charge on at least one of the silane and oxide within a chamber, functionalised nano-silica can be produced from a one-step reaction between the silane and the oxide. This is because electrostatically charging the gases increases the electron density of the reacting mixed gas, which causes the bonds of the oxide and silane to break more easily when reacting to produce silicas, hydrogens and monoxides.

As a result, due to the increased electron density of the reacting mixed gases, the outer layer of silica is coated with a functional group, which, in the case CO₂ is used, can imbue the Silica with a hydrophobic property.

Preferably, a first part of the reaction vessel, relative to a lower surface, comprises a containment region for containing hydrogen and monoxide produced from the reacting mixed gas proximate to the reacting mixed gas for facilitating the production of functionalised Silica. In this way, due the relative buoyancy of hydrogen and monoxide produced from the reacting mixed gas, the hydrogen and monoxide are contained in a region proximate to the reacting mixed gas. This helps to facilitate the production of hydrophobic Silica because the hydrogen and monoxide are utilised during the nucleation of the Silica to produce functionalised Silica.

Preferably, the delivery system is also arranged to deliver hydrogen and monoxide to the mixing chamber proximate to the reacting mixed gas for facilitating the production of functionalised Silica. In this way, hydrogen and monoxide are provided to the reacting mixed gas to facilitate the production of hydrophobic Silica.

Preferably, the containment region of the reaction vessel is shaped such that delivered silane and oxide converges. In this way, gases delivered to the mixing chamber converge near the first part of the mixing chamber.

The containment region of the reaction vessel may be bell-shaped or cylindrical.

The containment region may be formed by a container suspended in the reaction vessel and have a closed upper end and a lower end open into the reaction vessel.

The containment region is preferably enclosed by a wall forming the container.

The one or more outlets are preferably connected to the region of the reaction vessel outside of the containment region.

Preferably, said at least one of the silane and oxide is arranged to be charged prior to being delivered to the mixing chamber.

Preferably, the delivery system includes a portion made of at least one of: a triboelectrically sensitive material and a dielectric material, for charging the silane and/or oxide. In this way, the silane and/or oxide can be passively charged via the triboelectric material and/or actively charged via the dielectric material of the delivery system as the gases are delivered to the mixing chamber.

Preferably, the delivery system is a delivery tube and/or a storage vessel of the silane and/or oxide.

The delivery system may include conductive inlet pipes which pass through the mixing chamber for pre-charging said at least one of the silane and oxide gas using the charge imparted to the inlet pipes from the reaction in the mixing chamber.

Alternatively, the mixing chamber may be arranged to cause at least one of the silane, the oxide and a mixture thereof to be charged through interaction with the mixing chamber itself such that the gases brushing the wall generate a charge on the gases.

Preferably, a portion of the reaction vessel is made from at least one of: a triboelectrically sensitive material and a dielectric material for charging at least one of the silane and oxide. In this way, the silane and/or oxide can be passively charged via the triboelectric material and/or actively charged via the dielectric material of the vessel as the gases are in the mixing chamber.

Preferably, the delivery system is arranged to deliver the silane and oxide to the mixing chamber via inlets provided in the reaction vessel; and wherein at least one of said inlets is arranged to deliver the silane or oxide to the mixing chamber in a turbulent flow. Delivering the oxide and/or silane to the mixing chamber in a turbulent flow ensures a greater degree of collisions occur between silane and the oxide, as well, in the case of the vessel comprising triboelectrically sensitive material, increasing the amount of contact that occurs between the oxide and the surface of the vessel for better charging, thus increasing the efficacy of the production of functionalised Silica.

Preferably, the reaction vessel is elongate having a longitudinal axis, and at least one inlet is arranged to supply gas at an angle between 45 and 90 degrees relative to a longitudinal axis of the reaction vessel such that the inlet generally directs the gas towards the first part of the reaction vessel. In this way, the flow of oxide being delivered to the mixing chamber is turbulent and flows towards the opening of the delivery chamber. Further, this arrangement reduces the likelihood of gases, such as silane, flowing back up into the inlets, which is undesirable.

Preferably, the at least one inlet is the inlet for said oxide.

Preferably, the inlet for silane is in the containment region of the reaction vessel and arranged at an angle parallel to the longitudinal axis of the reaction vessel such that the inlet for silane generally faces the ground surface. In this way, silane is delivered to the delivery chamber, which allows control of the flow of silane such that a direct flow path from the silane to the reacting mixed gas can be achieved.

Preferably, the mixing chamber comprises a delivery means for delivering the silane to below the containment region. In this way, the flow of silane can be controlled and a direct flow path from the silane to the reacting mixed gas can be achieved.

Preferably, the inlet for silane extends into the mixing chamber, and the delivery means includes a cylinder that extends towards the inlet for silane, the cylinder having an opening to receive the inlet for silane into a confined space within the cylinder; and the cylinder is arranged to provide a flow path to below the containment region. In this way, the flow of silane can be controlled and a direct flow path from the silane to the reacting mixed gas can be achieved.

Preferably, the opening of the cylinder is proximate to below the containment region. In this way, silane is delivered directly to the reacting mixed gas.

Preferably, the opening is between the inlet for oxide and the containment region. In this way, silane is delivered below the containment region to the reacting mixed gas.

The inlet for silane nay be in the containment region of the reaction vessel and arranged at an angle parallel to the longitudinal axis of the reaction vessel such that the inlet for silane generally directs the silane towards the upper part of the containment region.

Preferably, the reaction vessel comprises a separation means for separating the gases produced such as hydrogen, oxides such as carbon monoxide and functionalised Silica.

The delivery system is preferably also arranged to deliver hydrogen and monoxide to the mixing chamber proximate to the reacting mixed gas for facilitating the production of functionalised Silica

Preferably, the oxide is at least one of carbon dioxide, nitrogen dioxide and sulphur dioxide.

In a second aspect of the invention, there is provided a method of producing functionalised Silica comprising the steps of: supplying silane and an oxide into a containment region; arranging for at least one of the silane and oxide to be charged; and mixing the silane and oxide to produce a reacting mixed gas.

Preferably, hydrogen and monoxide produced from the reacting mixed gas are contained proximate to the reacting mixed gas for facilitating the production of functionalised Silica.

Preferably, the silane is supplied to a region in the containment region that is proximate to the reacting mixed gas.

Preferably, at least one of the silane and oxide are arranged to be charged prior to being supplied to the containment region.

Preferably, at least one of the silane and oxide are arranged to be charged in the containment region.

Preferably, at least one of the silane and oxide is supplied to the containment region so as to cause it to flow turbulently.

Preferably, the method further comprises the step of separating produced hydrogen, oxide and functionalised Silica from one another.

Preferably, the produced hydrogen, oxide and functionalised Silica are separated via a batch process.

### BRIEF DESCRIPTION OF THE DRAWINGS

Embodiments of the invention will now be described by way of example, with reference to the drawings in which:

FIG. 1 is a cross-sectional view of a first embodiment of the reaction vessel;

FIG. 2a is a schematic view of hydrophobic Silica whereby the functional group is represented by R;

FIG. 2b is a schematic view of hydrophobic Silica whereby the functional groups are methyl groups;

FIG. 3 is a perspective view showing the reaction vessel attached to a temperature-controlled flow reactor and a separation device;

FIGS. 4a and 4b are a side views of a second embodiment of the reaction vessel;

FIG. 5 is a top view of the second embodiment; and

FIG. 6 is an exhaust arrangement.

### DETAILED DESCRIPTION

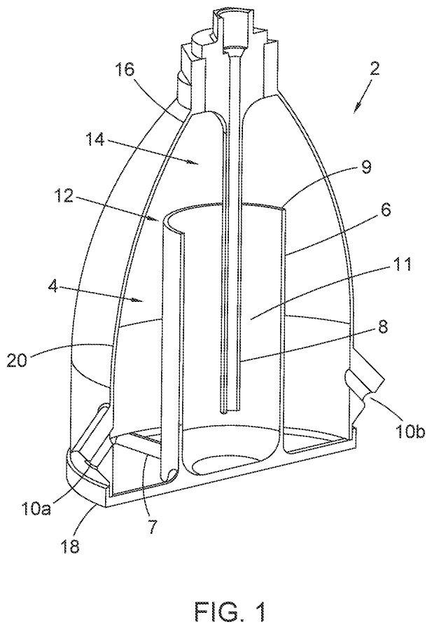

A first embodiment of a reaction vessel 2 will now be described. As illustrated in FIG. 1, the vessel 2 comprises a mixing chamber 4. The mixing chamber 4 comprises a reactant inlet 8, for receiving a silane (in this embodiment SiH₄, also known as Silicon tetrahydride but other silanes/hydrosilanes may be used, e.g. Disilane, Tri-silane etc.), and a pair of oxidizer inlets 10a, 10b, for receiving an oxide gas. The inlets 8, 10a, 10b allow the delivery of silane and an oxidiser into the mixing chamber 4 from a delivery system (not shown). In some cases, the reactant inlet 8 may be a plurality of inlets and/or there may be more or less than two oxidiser inlets 10a, 10b.

In this embodiment, the oxide is carbon dioxide (CO₂). In other embodiments, the oxide may be other oxides, such as nitrogen dioxide (NO₂) or sulphur dioxide (SO₂), or a mixture of at least two different oxides such as CO₂, NO₂ and SO₂. The oxide(s) may form part of an exhaust gas from a combustion and/or energy transformation industrial process. Additional gasses may be included, such as Methane, Ammonium, etc. which would add special properties to the functionalising of the Silica. For example, adding Nitrogen results in a Silicon-Nitride bond within the Silica

The reaction vessel 2, and thus the mixing chamber 4, is elongate having a top end 16, relative to a ground or lower surface (i.e., generally parallel relative to a ground surface of the earth), and an opposing bottom end 18 connected to the top end 16 via a diverging wall 20. In this embodiment, the top end 16 of the vessel 2 is bell-shaped, the advantage of which will be described later on. In general the top and bottom ends are arranged vertically one above the other which is advantageous when mixing the gases used together but the vessel may be oriented differently particularly if mixing of the gases is achieved in other ways than relying on their natural buoyancy.

The reactant inlet 8 is fed from an entry point at the top end 16 of the vessel 2 and extends into the mixing chamber 4 at an angle parallel to a longitudinal axis of the reaction vessel such that the inlet 8, i.e. the interface of the inlet at which gas is delivered into mixing chamber 4, generally faces the ground surface. In other embodiments, the inlet 8 may not be substantially parallel to a longitudinal axis of the reaction vessel.

The mixing chamber 4 comprises a substantially cylindrical delivery chamber 6 that is mounted to the mixing chamber 4 via mounting arms 7 such that the delivery chamber 6 is suspended centrally within the mixing chamber 4. The delivery chamber 6 is substantially concentric with the inlet 8 and has an opening 9 into a confined space 11 within the delivery chamber 6. The inlet 8 extends into the confined space 11 via the opening 9. In this way, silane being delivered to the mixing chamber 4 is arranged to flow into the mixing chamber 4 via the opening. The advantage of this flow path will be described later on.

The oxide inlets 10a, 10b are configured at an angle of e.g. 45 degrees relative to the longitudinal axis of the vessel 2 such that the inlets 10a, 10b generally direct oxide being delivered to the mixing chamber 4 towards the top end 16 of the vessel 2. In this way, the flow of oxide being delivered to the mixing chamber 4 is turbulent and flows towards the opening 9 of the delivery chamber 6. Further, this arrangement reduces the likelihood of gases, such as silane, flowing back up into the inlets 10a, 10b, which is undesirable.

In this document, the term ‘turbulent’ means a flow having a sufficiently high Reynolds number such that a reaction occurs between the oxide and silane. Preferably, the flow of oxide being delivered to the mixing chamber 4 has a Reynolds number greater than the point of laminar transition of the flow into turbulent flow.

In other embodiments, at least one of the oxide inlets is configured at an angle between 45 and 90 degrees relative to a longitudinal axis of the reaction vessel, and/or may be tangential relative to the vessel, such that the inlet generally directs the gas it is delivering to the mixing chamber towards the top end of the vessel 2 and/or with a tangential direction to cause swirling of the gas within the chamber.

The delivery system (not shown) comprises delivery tubes (not shown) that supply silane and oxide to the reactant inlet 8 and oxide inlets 10a, 10b respectively from respective storage vessels of oxide and silane (not shown). In this embodiment, the delivery tubes are made from silicone, which is a material that is able to receive and impart a charge triboelectrically onto the particles of gas via contact between the material and particles (herein such material is referred to as triboelectrically sensitive material). In this way, the silane and CO₂ are electrostatically charged prior to being delivered to the mixing chamber 4 due to sufficient contact between the gases and the triboelectrically sensitive material of the delivery tubes. In other words, silane and CO₂ become electrically charged as they pass through the delivery tubes.

In this arrangement, silicone is used as the triboelectrically sensitive material. In other arrangements, a triboelectrically sensitive material other than silicone, such as PTFE, VITON or Buna-N, may be used. The triboelectrically sensitive material should be compatible with at least silane and oxides, particularly oxides of carbon, nitrogen or sulphur. Preferably, the triboelectrically sensitive material is towards the negative end the triboelectric series spectrum. In some embodiments, only one of the delivery tubes comprises a triboelectrically sensitive material such that at least one of the silane or oxide is charged prior to being delivered to the mixing chamber 4. Further, in some arrangements, the delivery tubes are not made from silicone. In these cases, the delivery tubes are instead cladded with triboelectrically sensitive material, such as silicone. Further, in some arrangements, a charge may be imparted triboelectrically onto the particles of gas flowing through the delivery tubes via one or more meshes of triboelectrically sensitive material that are mounted within at least one of the delivery tubes. In some cases, the triboelectric material of the meshes are a dielectric material that can be polarized with an applied electric field. In this way, a charge may be imparted triboelectrically from the polarised dielectric mesh onto the particles of gas. In some arrangements, these meshes (i.e. a mesh made of at least one of a triboelectric and dielectric material) may also be mounted within the vessel 2 such that charge is imparted from the mesh onto the particles of gas within the vessel.

Thus, charge is imparted triboelectrically onto the particles of gas at least either via triboelectrically sensitive material and/or via dielectric material that is polarised with an applied electric field. In other words, the particles of gas can be charged triboelectrically in a passive manner via contact with triboelectrically sensitive material and/or in an active manner via contact with dielectric material that is polarised with an applied electric field. The triboelectrically sensitive material may also be a dielectric material this allowing both passive and active charging of the particles of gas. The importance of charging silane and CO₂ in this way will be described later on.

The mechanism of triboelectric charging between materials is well known to the skilled person. In the technical field of chemical processing, triboelectric charging is generally perceived as an undesirable effect because inadvertent discharging of static charge can occur. This is often managed by grounding parts of the chemical processing apparatus to remove any build of static charge on the apparatus.

As silane and the CO₂ are delivered into the mixing chamber 4, the two gases flow towards a mixing region 12 that is proximate to and surrounds the opening 9 of the delivery chamber 6, where the gases mix together and begin to react. The reaction results in the production of Silica, as will be described later on.

The delivery system is also arranged to deliver silane and CO₂ to the mixing chamber 4 under pre-determined conditions, such as pressure, speed etc, and at a suitable stoichiometric ratio of silane to CO₂. The pre-determined conditions and stoichiometric ratio of silane to CO₂ are controlled by adjusting the pressure and/or temperature of silane and CO₂ being delivered to the vessel 2. The mixing chamber 4 is an enclosed area, in communication with the inlets 8, 10a, 10b, for which mixing can occur between silane and the CO₂.

The reaction may also be controlled by adjusting the temperature and/or pressure of the silane and the temperature and/or pressure of the CO₂ being delivered via the delivery system. For example, a decrease in the temperature and/or pressure of the CO₂ being delivered can be compensated for by an increase in temperature and/or pressure of silane being delivered to maintain a desired mass flow rate or pressure of the flow of gases in the mixing chamber 4. In this way, the stoichiometric ratio, the Reynolds number of the flows of silane and CO₂, and the reaction of silane and the CO₂ can be controlled.

A control system (not shown) is arranged to monitor the stoichiometric ratio and/or pressure of the mixed gases in the mixing chamber 4. This is achieved by monitoring the mass flow rate and/or pressure and/or temperature of the mixed gas and adjusting the mass flow rate and/or pressure and/or temperature of the silane being delivered accordingly to maintain the desired stoichiometric ratio and/or pressure of the mixed gas.

In this embodiment, the temperature and/or pressure of the silane is adjusted to control the stoichiometric ratio and/or pressure of the mixed gas. In other embodiments, the control system may control the mass flow rate and/or pressure and/or temperature of at least one of the silane and the CO₂ being delivered accordingly to maintain the desired stoichiometric ratio and/or pressure of the mixed gas.

In some embodiments, the mixing chamber 4 may comprise swirlers and/or a pintle and/or a mesh to facilitate the mixing of silane with CO₂ in the mixing chamber 4. The swirlers, pintle or a mesh may comprise triboelectrically sensitive material to also facilitate electrostatically charging the silane and CO₂ in the mixing chamber 4.

The reaction that occurs between silane and the CO₂ will now be described. Silane is pyrophoric in nature, allowing an instant hypergolic reaction to occur with oxides when the turbulence of the fluid mixture is sufficiently high. In other words, the reaction occurs when the two gases mix together above a predetermined Reynold's number, which, as discussed above, is determined by controlling the mass flow rate at which silane and CO₂ are delivered to the mixing chamber 4. In this way, it is ensured that collisions occur between silane and CO₂ such that silane reacts with the CO₂.

This reaction produces silicon dioxide (silica), hydrogen, heat energy and a monoxide of the initial oxide, i.e. an oxygen atom is stripped from the oxide. This would provide nitrogen oxide (NO) when NO₂ is the initial oxide, sulphur oxide (SO) when SO₂ is the initial oxide and carbon monoxide (CO) when CO₂ is the initial oxide. This reaction can be generally summarised as:

SiH₄+2XO₂=SiO₂+2XO+2H₂+E (1)

whereby X may denote carbon, nitrogen or sulphur and E denotes the release of energy.

As the mixture reacts, silica reacts with compounds such as the monoxide and the hydrogen to produce Si—C—R and/or Si—O—R bonds particularly on its surface structure, whereby R represents organic functional groups such as methyl, alkyls, carbonyls etc. Nucleation and aggregation of this silica with these bonds begins to occur to form silica having an organic functional group, such as methyl, alkyl, carbonyl, etc groupings, coating on the surface of the silica particle giving the surface a functional property, such as a hydrophobic property. In other words, the reaction produces functionalised silica, i.e., silica having a functional chemical group attached to it. The type of functional chemical group attached will depend on the type of oxide used in the reaction, as well as the reaction conditions.

In this embodiment, silane is used with carbon dioxide to produce hydrogen, silica, carbon monoxide and heat energy:

SiH₄+2CO₂=SiO₂+2CO+2H₂+E (2)

However, as the gases initially mix a number of intermediate reactions may take place which can lead to the production of carbon, silicon, water and other products. Typical reactions are as follows:

SiH₄+CO₂=SiO₂+C+2H₂O (3)

SiH₄+CO₂=Si+CO+2H₂O (4)

These products may only exist transiently before taking part in further reactions. Carbon as an example in a nano state can react with steam and re-form to make hydrogen and carbon monoxide.

During these reactions, transient hydrogen and carbon compounds or radicals are produced which may also combine with each other to produce methyl, alkyl, and other functional groups, which can bond to the silica being produced to form a functionalised coating on the surface which can provide hydrophobic properties to the silica, as described in more detail below.

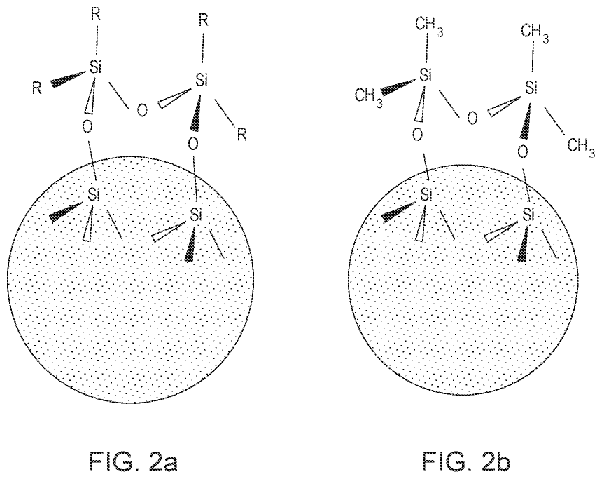

As illustrated in FIG. 2b, in this case, the organic functional group coatings formed on the surface are primarily methyl groups, giving the surface a hydrophobic property. Other groups, such as ethyl groups, may also be formed on the surface. FIG. 2a illustrates a schematic view of Silica whereby the functional group is represented by R.

When CO₂ is used as the oxide, the functional groups that are commonly formed are such as alkanes, aldehydes, ketenes or ethers. Other functional groups may form such as alkynes, alcohols, carboxylic acids, esters and acid anhydrides, although these are likely to be rarely. Depending on conditions and available materials haloalkenes, aryls, epoxides and acyl halides might be formed although this is less likely.

When Nitrogen dioxide (NO₂) is used as the oxide, the functional groups that are likely to form may include nitrides, amines and amides. Other functional groups that might be formed are nitrate, nitrosos, cyanates, isocyanates, azos, imines and imides and to a lesser extent azides and nitro compounds.

When Sulphur dioxide (SO₂) is used as the oxide, the functional groups that are likely to form may be thiol and sulfide. Other functional groups that might be formed are disulphides, sulfoxides, sulphenes as well as compounds of sulphinic acid, sulphonic acid and sulfonate ester and to a lesser extent thiocyanates, thials, isothiocyanates and thioketones.

The particle size of the silica produced from the above reaction is between 5-125 nm—the silica is therefore considered nano-silica. In this arrangement, the particle size is influenced by the magnitude of the electric field within the vessel 2.

The electric field in the vessel 2, which may be in the region of 3-9 kV, is generated as a result of the charged particles and/or any charging of the vessel 2. The particle size can thus be manipulated by controlling the magnitude of the electric field within the vessel 2, for example by controlling a voltage applied to the vessel 2 when charging the vessel 2, which is described later on. The collision rates between the particles of silica and the particles of hydrogen and carbon define the shape and size of the particles after the nucleation process concludes. An example of the molecular weight of the produced nano-silica is around 60.08 g mol⁻¹ with a specific surface area (SSA) of around 40 m²g⁻¹ and a density of 18 g/l.

The formation of the functional chemical group, which in this arrangement is an alkyl group such as a methyl group, on the Silica occurs due to the silane and CO₂. and/or the vessel being electrostatically charged. Charging the gases in this way increases the electron density of the reacting mixed gas, which causes the bonds of the carbon dioxide and silane to break more easily when reacting to produce silicas, hydrogens and carbon/carbon monoxides. As a result, due the increased electron density of the reacting mixed gases, the outer layer of silica is coated with a hydrophobic methyl group or other functional group.

The agglomeration rate of the Silica is influenced by the degree to which the gases and/or the vessel are electrostatically charged. Generally, the greater the degree of electrostatic charge imparted on the reacting particles, the greater the agglomeration rate will be of Silica. The phobicity of the hydrophobic Silica and the size distribution of the Silica are both influenced by the degree and rate at which the Silica has agglomerated. Thus, controlling the degree to which the gases and/or the vessel are triboelectrically charged allows these aspects of the Silica to be controlled as desired by the user. This control may be achieved by adjusting the length and/or the thickness of the triboelectrically sensitive material being used to impart the electrostatic charge on the reacting particles, such as the length and/or thickness of the delivery tubes. In some arrangements, this control may also be achieved by adjusting the type of triboelectrically sensitive material used.

As discussed above, the silane and CO₂ are triboelectrically charged prior to being delivered into the mixing chamber 4 via the delivery tubes that deliver the silane and CO₂ to the reactant inlet 8 and oxide inlets 10a, 10b respectively from their respective storage vessels. In other embodiments, at least one of the storage vessels may comprise triboelectrically sensitive material, such as glass or Polytetrafluoroethylene (PTFE), instead of or in addition to the delivery tubes. In yet other embodiments, the vessel 2 may comprise triboelectrically sensitive materials like dielectrics that do not chemically react with silane or other products of the reaction, instead of or in addition to the delivery tubes and/or the at least one storage vessel.

In the case only the vessel 2 comprises triboelectrically sensitive material, silane and CO₂ particles are triboelectrically charged as they contact and rub the surface of the vessel 2. This arrangement may be beneficial when used in combination with the delivery tubes and/or the storage vessels comprising triboelectrically sensitive material.

In some embodiments, the vessel 2 may be made of a conductive material that is charged, such as via a voltage generator, prior to and/or during the reaction. In this case, the vessel 2 may also comprise insulation to prevent any sparking that may occur as the vessel 2 is charged. In some cases, the insultation is a dielectric material that separates the mixing chamber from the conductive material. The dielectric material is thus polarized as the conductive material is charged such that the dielectric material imparts a charge onto particles within the mixing chamber 4 as previously described. In this way, electrostatic charging of silane and CO₂ within the mixing chamber 4 can be achieved (if the particles are not already triboelectrically charged) or supplemented (if the particles are already triboelectrically charged). In the latter case, this improves the efficacy of the production of hydrophobic Silica. Alternatively, or additionally, in some cases, an inside surface of the vessel 2 may be cladded with triboelectrically sensitive material, such dielectric, to facilitate electrostatically charging the silane and CO₂ in the mixing chamber 4

The addition of organic groups to the Silica, which in this arrangement are alkyl groups, imbues the Silica with a hydrophobic property because the organic outer layer changes the chemical structure of the material from the Si—OH grouping on typical hydrophilic silica, blocking ingress of water through the structure of the material.

The formation of the hydrophobic methyl group on the silica is supplemented by the arrangement of the vessel 2, as will now be described. As explained above, silane is delivered to the mixing chamber 4 via the delivery chamber 6, which has an opening 9 that allows silane to flow into the mixing region 12, which is proximate to and surrounds the opening 9 of the delivery chamber 6. CO₂ is delivered to the mixing chamber 4 such that it also flows towards the mixing region 12. It is at this region that silane and CO₂ meet, mix, and begin to react.

Due to their relative buoyancy to the silane and CO₂, the hydrogen and carbon monoxide produced from the reaction flow towards the top end 16 of the vessel 2. The hydrogen and carbon monoxide are thus trapped or contained in a region 14 between the top end 16 of the vessel 2 and the opening 9. In this way, hydrogen and carbon monoxide produced from the reacting mixed gas are trapped proximate to the reacting mixed gas, and silane is delivered to the mixing region 12 below the trapped hydrogen and carbon monoxide. This helps to facilitate the production of hydrophobic Silica because, as explained above, hydrogen and carbon monoxide are utilised during the nucleation of the Silica, hydrogen and carbon to produce functionalised Silica. In some arrangements, the vessel 2 may comprise vents for removing excess carbon monoxide and hydrogen from the trapping region.

The distance between the top end 16 of the vessel 2 and the opening 9 of the delivery chamber 6 can be optimised during manufacture of the vessel 2 such that trapped hydrogen and carbon monoxide are suitably proximate to the reacting mix gas. The location of trapped hydrogen and carbon monoxide can also be influenced by controlling the mass flow rates of the silane and CO₂ being delivered to the mixing chamber 4, the dimensions and pressure of the mixing chamber 4, as well as the permeability of material of the vessel for hydrogen and carbon monoxide.

As explained above, the vessel 2, and thus the mixing chamber 4, is bell-shaped. This allows gases delivered to the mixing chamber 4 to converge near the top end 16 of the mixing chamber 4. In other embodiments, the vessel 2, and thus the mixing chamber 4, may be another suitable shape, such as cylindrical, that allows hydrogen and carbon monoxide to be contained proximate to the mixing region 12.

The production of hydrophobic Silica is further facilitated by the turbulence induced in the delivered CO₂, due to configuration of the oxide inlets 10a, 10b. Delivering the oxide to the mixing chamber 4 in a turbulent flow ensures a greater degree of collisions occur between silane and CO₂, as well, in the case of the vessel comprising triboelectrically sensitive material, increasing the amount of contact that occurs between the CO₂ and the surface of the vessel for better charging, thus increasing the efficacy of the production of hydrophobic Silica.

Although in the embodiment above, silane is delivered via the top end of the vessel 2, alternatively, silane could be delivered to the mixing chamber 4 from the bottom and/or sides of the delivery chamber 6.

In some embodiments, there may be no delivery chamber 6. In this case, the reactant inlet 8 may not extend into the mixing chamber 4. Here, silane is delivered to the mixing chamber 4 at the top end 16 of the vessel 2. This arrangement may be less favourable, because less silane may react with CO₂ as it descends towards the bottom end 18 of the vessel 2.

In some embodiments, the delivery of silane and oxide may be done in reserve such that oxide is delivered via the inlet 8 and silane is delivered via the inlets 10a, 10b.

As noted above, oxides other than carbon dioxide may be used, for example, nitrogen dioxide:

SiH₄+2NO₂=SiO₂+2NO+2H₂+E (5)

In this case, the organic functional group coatings formed on the surface are amine groups.

The vessel 2 comprises a material that has a catalytic effect on the reaction between silane and the CO₂. In the case where the mixing chamber 4 comprises a pintle, the pintle may comprise the catalytic material to increase the surface contact between the mixed gases and the catalytic material.

In some embodiments, one or more additional gases, such as inert gas or catalytic gas, may be injected into the vessel 2 to further control the rate of reaction between silane and CO₂. The rate of reaction of silane with the CO₂ can be increased or decreased depending on the one or more additional gases supplied to the vessel 2. In this case, the vessel 2 comprises one or more additional inlets supplying the one or more additional gases to the mixing chamber 4. For example, the vessel 2 may comprise an additional inlet for supplying a catalytic gas, such as nitrogen, to increase the rate of reaction. The catalytic gas may be another type of noble gas, such as Argon.

The bottom end 18 may provide a surface for supporting the vessel 2 in an orientation such that gravity facilitates the flow of products created by the reacting mixed gas (i.e. Silica, hydrogen and carbon monoxide), from the top end 16 to the bottom end 18.

The products descend, facilitated by gravity, from the top end 16 towards the bottom end 18. The Silica may further collide as it descends towards the bottom end 18 causing further agglomeration. In some cases, the vessel 2 may be arranged to actively facilitate the flow of the products to the bottom end 18 of the vessel 2. For example, the vessel 2 may comprise earthed or negatively charged conductive material at the bottom end 18 to facilitate the flow of the products towards the bottom end 18 of the vessel 2.

The bottom end 18 of the mixing chamber 4 is wider than the top end 16 such that the dimensions of the chamber 4 proximate to the top end 16 increases towards the bottom end 18. This results in a pressure differential between the top and bottom ends 16, 18 which facilitates the flow of the products towards the bottom end 18 from the top end 16. The increase in dimensions between the top and bottom ends 16, 18 of the mixing chamber 4 may also facilitate agglomeration of the Silica.

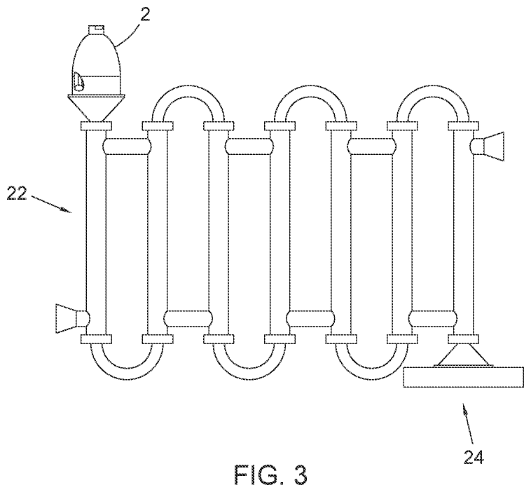

As illustrated in FIG. 3, the bottom end 18 of the vessel 2 is coupled to and in fluid communication with a plug flow reactor 22. Here, Silica, hydrogen and carbon monoxide flows through the plug flow reactor until it reaches a particulate separator 24, which is arranged to separate these products from one another. The plug flow reactor 22 induces a turbulent flow on the products flowing within it (i.e. the Silica, hydrogen and carbon monoxide), which assists in further agglomeration of the Silica.

In some embodiments, the vessel 2 may not be coupled to a plug flow reactor and particulate separator. In this case, Silica, monoxide and hydrogen are removed from the vessel 2 once the amount of Silica produced reaches a particular threshold amount. In other words, removal of Silica, monoxide and/or hydrogen from the vessel 2 can be achieved using a batch process, for example using a liquid trap with ethanol to trap the Silica. In some cases, all of these gases are separated from one another. In other cases, Silica is separated from the hydrogen and carbon monoxide resulting a mixture of hydrogen and monoxide. Extracting and separating the gases in this way is useful because both hydrogen and the monoxide, in particular carbon monoxide, are valuable products that can be utilised in various industrial chemical processes, either as separate gases or as a mixture.

Therefore, the method of reacting silane with oxide as described by the present invention results in not only desirable functionalised Silica, but also valuable by-products of hydrogen and monoxide.

In some arrangements, the vessel 2 may be an input structure/portion of a plug flow reactor. In this case, charged silane and/or CO₂ are delivered to the input portion of the plug flow reactor, which is equivalent to a mixing chamber, to produce functional Silica. This arrangement may be more beneficial in allowing for large scale quantities of Silica to be produced. In this case, hydrogen and carbon monoxide are injected into the plug flow reactor at one or more locations along the reactor to facilitate the reaction between silane and CO₂. The length of the plug flow reactor is optimised to ensure sufficient reaction and agglomeration occurs to produce the functionalised Silica.

In some embodiments, the agglomeration of the Silica due to the variation in dimensions of the mixing chamber 4 can also be influenced by adjusting the degree of said variations along the length, i.e. by having a narrower or wider bell-shaped mixing chamber 4. Controlling the agglomeration of the Silica, via selection of the dimensions of the mixing chamber 4, is advantageous as will be described in more detail further below.

The design parameters of the vessel 2 and the conditions under which the reaction of silane and the CO₂ occurs influences the agglomeration of the Silica. In other words, the design parameters and reaction conditions can be controlled to produce variations of Silica as desired by the user. Therefore, in other embodiments, the design parameters of the vessel 2 and the conditions under which the reaction occurs may be varied to calibrate the output of Silica being extracted from the vessel as desired by a user. The design parameters may be decided during manufacture of the vessel 2.

As described above, the design parameters and conditions used to calibrate the output of Silica include: the shape of the mixing chamber 4; the differing dimensions between the ends 16, 18 of the chamber 4; the distance between the ends 16, 18 of the chamber 4; the temperature and/or pressure of the delivered silane and/or oxide; the temperature and/or pressure of within the chamber 4; and the stoichiometric proportion of silane and CO₂. Other embodiments may have a different combination and/or degree of any of the above-mentioned design parameters and/or conditions depending on the particular output of Silica desired by the user.

In some cases, additional gases may be delivered to the mixing chamber 4 along with silane and the oxide and/or the vessel 2 may be flushed with other gases before the silane and the oxide are delivered to the mixing chamber 4. For example, the vessel 2 may be flushed with nitrogen before silane and CO₂ are delivered to the mixing chamber 4 and/or nitrogen may be delivered to the chamber 4 along with silane and CO₂. This introduces a unique nitrogen-based bond structure in the produced Silica that can be detected, for example using infrared (IR) detection. This type of Silica has applications in the security industry. Items can be coated with this Silica, allowing IR detection systems to detect the unique nitrogen-based bond within the coating on the item. In this way, counterfeit items not having the applied coating can be identified.

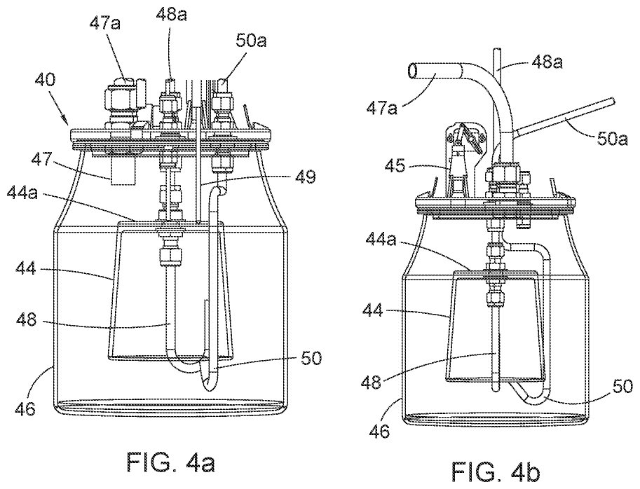

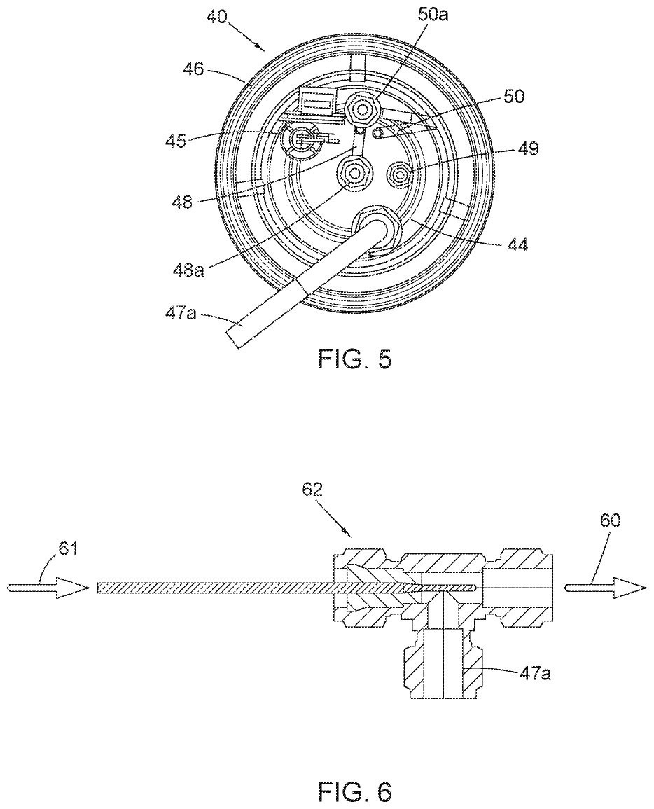

A further embodiment of the invention will now be described. As illustrated in FIG. 4a, the vessel 40 comprises a mixing chamber 44. The mixing chamber 44 comprises a reactant inlet 48 for receiving silane and an oxidizer inlet 50 for receiving an oxide gas. The inlets 48 and 50 allow the delivery of silane and the oxidiser into the mixing chamber 44 from a delivery system (not shown) via feed lines 48a and 50a respectively. The reactant inlet 48 may be a plurality of inlets and there may also or alternatively be more than one oxidiser inlet 50. The reactant inlet is preferably slightly higher then then oxide inlet, as shown in FIGS. 4a and 4b

The inlets 48, 50 include a pipe section have a generally J-shaped from with the gas exit at the end. The J-shape produces asymmetric flows at low pressure and flow. This will cause mixing both by pressure differential but also by the gas hitting the walls of the inner glass cover 44 both charging the material through rubbing but mixing through swirling the gases.

The inlet pipes pass at least partly through the mixing chamber 44 such that as the reaction progresses, the charges produced on the reaction products is transfer to the inlet pipes and acts to pre-charge the incoming reactants: silane and oxide.

The inlet 48 passes through the mixing chamber 44 and then doubles back to direct the silane into the mixing chamber. Inlet 50 passes around the mixing chamber 44 and the J-shape extends under the bottom of the mixing chamber and directs the oxide gas into the mixing chamber. This arrangement is exemplary and either or both inlets may pass through the mixing chamber like inlet 48 or outside the mixing chamber like inlet 50.

The hypergolic properties of the Silane and Carbon dioxide (or other oxide) mixture (“SiTet-CO”) require a physical method of premixing to ensure the hypergolic reaction takes place. The mixing chamber 44 provides a space where the gases can be introduced to form the hypergolic mixture. Due to the nature the hypergolic mixture, premixing outside of the chamber is not desirable to prevent pre-ignition. It may also lead to a phenomenon known as a semi-stable mixture that can cause a delayed explosive reaction.

The chamber itself is important to maintain control of the reaction and avoid the risk of a misfire. A hypergolic mixture such as SiTet-CO can be semi-stable, in that it may mix but not fire at all, have a delayed reaction or have a spontaneous explosive reaction. Ignition at the wrong stage can result in incomplete combustion or undesirable products similar to pre-ignition or incomplete combustion in an internal combustion engine. The pre-mixing chamber is designed to ensure immediate ignition as the gases are mixed.

The chamber 44 is shown with a flat top 44a but other shapes such as domed or other shapes also work well.

The material selection for the mixing chamber 44 is important as it can impact the reaction catalytically. In this embodiment, glass is used for the mixing chamber 44 but other materials may be used. Non-conductive materials avoid electrical discharge due to electrostatic charging of the contents of the chamber. Non-conductive material will also tend to impart a greater potential static charge.

However, conductive material can still be used but careful grounding of the conductive parts is desirable to inhibit charging and electrical discharge. For example, in this embodiment, the inlet and outlet piping is metal, although it could be glass.

The rubbing action of the gases (tribo-electrical effect) on insulative material helps to generate a desirable static charge necessary to aid the reaction progress. Insulative materials can also aid in maintaining the temperature within the vessel, as the reaction operates well above room temperature, typically 30-200° C. Insulative material also reduces sparking risks which is important in systems with Hydrogen to avoid accidental combustion.

Conductive materials such as stainless steel can be used but this can result in carburization of the surface of the steel. In its initial form, the Chromium in the surface of the steel actively supports or catalyses the reaction but over time, the presence of carbonyl groups in the atmosphere near the surface, slowly coat the surface with a carburized layer which inhibits the reaction. This can me mitigated by using a glass or similar coating on the stainless steel and providing charge to the steel, but this does complicate the manufacture of the reactor.

The dimensions of the chamber 44 will be adjusted accordingly depending on the parameters of the reactants used, e.g. pressure and flow rate of the Silane and Carbon dioxide.

As noted above, control of the ignition of the mixture is important and the hypergolic mixture may not spontaneously react at the desired time, particularly if the reactor has just been started and under certain other circumstances. In an internal combustion engine it is preferable to start with a higher ratio of hydrocarbons or a “rich” mixture to initiate and maintain reliable combustion. In the present invention.

a low charge arrangement at the start of operation e.g. a “lean” mixture, is used so a lower ratio of silane is to start and then once combustion has occurred much greater charge is imparted by the silica onto the glass allowing a normal mixture to be used. Not having a lean mixture at the start risks “flooding” the engine leading to semi-stable mixtures or “misfires”.

The reaction of Silane with Oxygen tends to allow a more reliable ignition which may be used to initiate the reaction of the main SiTet-CO mixture. To enable this, a small access pipe 45 is provided which allows restricted access to oxygen, to commence ignition. This is controlled by a solenoid or similar which controls access to the chamber so that it can be closed once the reaction is operating and so controlled amounts of oxygen can be introduced.

Oxygen, or typically atmospheric air containing oxygen, is provided into the upper part of the chamber 44 and due to the relative buoyancy of the gases interacts with the Silane which is buoyant in the carbon dioxide such that it will tend to rise above the carbon dioxide. This allows the oxygen to react with the Silane. The reaction between Silane and oxygen tends to be more reliable and will tend to initiate spontaneously which initiates the reaction of the Silane with the carbon dioxide.

The feeding of oxygen via the access pipe 45 acts like a sparkplug in this regard. It is designed to allow reaction to initiate whilst also immediately closing, once it detects a temperature increase, a plunger style cap is used to stop escape of solid product and Hydrogen through it. A temperature probe 49 is provided for monitoring the temperature in the vessel. The control of the injected Oxygen allows control of the ignition timing of the main reactants in the vessel.

The main reduction chamber 46 encloses the mixing chamber 44 and inlets 48, 50. This is used to ensure the reaction is controlled within a fixed volume and separated from the external atmosphere whilst containing the solid material formed in the reaction.

The chamber 46 is ideally made from material that is catalytically and thermally compatible with the fuel used and the reaction. For example, forming the chamber 46 from a metal material tends to cause the reaction to liberate carbon monoxide in undesirable quantities in some circumstances. Although, in some circumstances the production of a hydrogen/carbon monoxide mixture may be a desired outcome—see reactions above. As noted above, the surface of the stainless steel vessel is catalytically effective to the reaction but also has an oxide layer that will poison overtime due to carburization. Under ideal circumstances, the reaction will borrow oxides from the oxide layer of the stainless steel (described like: SS—O) and replace with other oxides speeding up reaction. However, eventually an oxide might be replaced with a bonded Carbon atom so (SS—C/SS—C—O) blocking further reaction and thereby poisoning the surface. This can be overcome with active electrical input to the metal or by using a different material, such as glass.

The exhaust pipe 47a is connected to an outlet 47 inside the reduction chamber 46. This outlet 47 allows the gases produced during the reaction, e.g. hot Hydrogen, to escape the chamber 46. It also allows the other solid products to be removed from the chamber 46. The mixture of gases and solids leave the chamber 46 via the pipe 47a and are passed to a subsequent ejector vacuum system 62, shown in FIG. 6, which removes the remaining hydrogen and solid matter once the chamber has filled. The pipe 47a may join other similar exhaust pipes which feed the reaction products from multiple reaction vessels a hopper for collecting the Silica produced. The Hydrogen produced is separated from the Silica to allow the Hydrogen to be collected or used and the silica to be removed.

The reactor is run in a batch process with the hydrogen and any other gasses 60 produced after each cycle removed via the exhaust pipe 47a to a storage or separator tank (not shown). The Silica produced remains in the chamber although due to the low particle size and density, some may be drawn out with the gases. The material has exceptionally low density so separating from flowing gas is difficult. The vessel is arranged to have static flow or no flow momentarily between cycles, to allow Hydrogen's buoyancy, especially when hot, to cause it to escape the vessel and leave the material to settle in the chamber 46. After a number of cycles, the Silica will build up in the chamber and will eventually need to be purged. This is achieved using the ejector vacuum system 62. As shown in FIG. 6, Nitrogen gas (or some other preferably inert purging gas) is fed 61 into the ejector vacuum system 62 which includes a venturi type vacuum arrangement which draws the contents, including any remaining gas and the Silica produced over several cycles, out through the exhaust.

Without the ejector vacuum unit 62 to cause the flow out of outlet, the hydrogen concentration in vessel will increase leading to disequilibrium of reactants or possible ignition of the hydrogen due to having pyrophoric gas in contact with the hydrogen. If the chamber 46 is not purged in a batch process, for example by having continual flow, can lead to a reduction in product due to the previously produced Silica material interfering with subsequent reactions.

In order to maximise efficiency of the reactions, the reaction vessel is ideally operated at around atmospheric pressure, with the reactants injected at a higher pressure which may be just above atmospheric pressure.

After a reaction is completed, the reaction vessels are preferably purged using Carbon Dioxide to remove any residual explosive Hydrogen and Carbon monoxide products produced.

The flow rate of the gases fed into the reaction chamber can be adjusted to manipulate the characteristics of the reaction products. Higher flow rates tend to alter the silica production producing more elemental silicon and less of the silica product. The temperature also tends to increase at higher rates with temperature rising to above 200° C. At higher rates, the hydrogen produced tends to be combusted. By operating at a higher temperature of say 200° C. or higher, the system could be used to manufacture Silicon enriched silica and produce electrical power via steam generating heat exchangers.

The reactants are added sequentially into the reaction vessel. The carbon dioxide is fed in first and then the silane is fed in. The reactants can be done separately but it is generally more efficient to load them sequentially. This can help to reduce the risk of misfire and avoids the possibility of exhausting the silane. This can happen because the flame is effectively blown out by the extra flow from the oxidiser or the hypergolic reaction isn't able to sustain.

In the embodiments above, apart from when used with the plug flow reactor, the reaction chambers tend to operate in a batch processing manner with the reactants introduced into the chamber, the reaction takes place and then the reaction products are removed ready for a further cycle. Several of these reaction vessels may be arranged to operate in parallel as a battery or bank of reaction vessels, each operating to carry out the reaction and to then be purged. Several of these banks (even where the “bank” includes a single reaction vessel) may be connected to operate together with each battery operating out of synchronisation with the other banks.

For example, 3 banks of 100 units may run on three minute cycles. If the system is running all at once you have a burst of heat, a burst of silica and a burst of hydrogen. This would mean design for higher pressure to feed the system overall, design for a system that stop starts, i.e. accumulation points for CO₂ and hydrogen, and greater management of more dangerous quantities of combustible gas.

Whereas cycling in one-minute delayed stages, the three banks provide the same output over three minutes with reduced risk and more continuous rather than bursts of output. This can be important for integration with current CO₂ producing systems.

In this way, while one battery is reacting, then next one may be purging the reaction products whilst the third is preparing the reaction chamber for the next cycle. In this way, the overall system may operate to provide a near continuous production cycle even though the banks are operating in a batch manner. This allows the reaction products to be produced in a more continuous manner rather than in a periodic manner.

1. A reaction vessel for producing functionalised Silica comprising:
an enclosed mixing chamber for mixing silane gas and an oxide gas,
a delivery system for delivering the silane and oxide to the mixing chamber to facilitate mixing of the silane and oxide within the mixing chamber; and
one or more outlets through which the reaction products are removed from the reaction vessel.

2. A reaction vessel according to claim 1, further comprising arranging at least one of the silane and oxide gas to be charged.

3. A reaction vessel according to claim 1, wherein a first part of the reaction vessel, relative to a ground surface, comprises a containment region for containing the reaction products produced from the reacting mixture of silane and oxide gas proximate to the reacting mixed gas for facilitating the production of functionalised Silica.

4. A reaction vessel according to claim 2, wherein the containment region of the reaction vessel is shaped such that delivered silane and oxide converges.

5. A reaction vessel according to claim 2, wherein at least the containment region of the reaction vessel is bell-shaped.

6. A reaction vessel according to claim 2, wherein at least the containment region of the reaction vessel is cylindrical.

7. A reaction vessel according to claim 2, wherein the containment region is suspended in the reaction vessel and has a closed upper end and a lower end open into the reaction vessel.

8. A reaction vessel according to claim 7 wherein the containment region is enclosed by a wall.

9. A reaction vessel according to claim 7 wherein said one or more outlets are connected to the region of the reaction vessel outside of the containment region.

10. A reaction vessel according to claim 1, wherein said at least one of the silane and oxide is arranged to be charged prior to being delivered to the mixing chamber.

11. A reaction vessel according to claim 10, wherein the delivery system includes a portion made of at least one of a triboelectrically sensitive material and a dielectric material, for charging at least one of the silane and the oxide.

12. A reaction vessel according to claim 11, wherein the delivery system includes at least one of: a delivery tube and a storage vessel for at least one of the silane and the oxide.

13. A reaction vessel according to claim 1, wherein the delivery system includes conductive inlet pipes which pass through the mixing chamber for pre-charging said at least one of the silane and oxide gas using the charge imparted to the inlet pipes from the reaction in the mixing chamber.

14. A reaction vessel according to claim 1, wherein the mixing chamber is arranged to cause at least one of the silane, the oxide and a mixture thereof to be charged through interaction with the mixing chamber.

15. A reaction vessel according to claim 1, wherein a portion of the reaction vessel is made from at least one of: a triboelectrically sensitive material and a dielectric material, for charging at least one of the silane and oxide.

16. A reaction vessel according to claim 1, wherein the delivery system is arranged to deliver the silane and oxide to the mixing chamber via inlets provided in the reaction vessel; and
wherein at least one of said inlets is arranged to deliver the silane or oxide to the mixing chamber in a turbulent flow.

17. A reaction vessel according to claim 16, wherein the reaction vessel is elongate having a longitudinal axis, and said at least one inlet is arranged to supply gas at an angle between 45 and 90 degrees relative to a longitudinal axis of the reaction vessel such that the inlet generally directs the gas towards the containment region of the reaction vessel.

18. A reaction vessel according to claim 16, wherein said at least one inlet is the inlet for said oxide.

19. A reaction vessel according to claim 18, wherein the inlet for silane is in the containment region of the reaction vessel and arranged at an angle parallel to the longitudinal axis of the reaction vessel such that the inlet for silane generally faces the ground surface.

20. A reaction vessel according to claim 19, wherein the mixing chamber comprises a delivery means for delivering the silane to below the containment region.

21. A reaction vessel according to claim 20, wherein the inlet for silane extends into the mixing chamber, and the delivery means includes a cylinder that extends towards the inlet for silane, the cylinder having an opening to receive the inlet for silane into a confined space within the cylinder; and
wherein the cylinder is arranged to provide a flow path to below the containment region.

22. A reaction vessel according to claim 21, wherein the opening of the cylinder is proximate to below the containment region.

23. A reaction vessel according to claim 22, wherein the opening is between the inlet for oxide and the containment region.

24. A reaction vessel according to claim 18, wherein the inlet for silane is in the containment region of the reaction vessel and arranged at an angle parallel to the longitudinal axis of the reaction vessel such that the inlet for silane generally directs the silane towards the upper part of the containment region.

25. A reaction vessel according to claim 1, wherein the reaction vessel comprises a separation means for separating the gases and functionalised Silica produced.

26. A reaction vessel according to claim 1, wherein the delivery system is also arranged to deliver hydrogen and monoxide to the mixing chamber proximate to the reacting mixed gas for facilitating the production of functionalised Silica.

27. A reaction vessel according to claim 1, wherein the oxide is at least one of carbon dioxide, nitrogen dioxide and sulphur dioxide.

28. A method of producing functionalised Silica comprising the steps of:
supplying silane and an oxide into a containment region;
arranging for at least one of the silane and oxide to be charged; and
mixing the silane and oxide to produce a reacting mixed gas.

29. A method according to claim 28, wherein hydrogen and monoxide produced from the reacting mixed gas are contained proximate to the reacting mixed gas for facilitating the production of functionalised Silica.

30. A method according to claim 28, wherein the silane is supplied to a region in the containment region that is proximate to the reacting mixed gas.

31. A method according to claim 28, wherein said at least one of the silane and oxide are arranged to be charged prior to being supplied to the containment region.

32. A method according to claim 28, wherein said at least one of the silane and oxide are arranged to be charged in the containment region.

33. A method according to claim 28, wherein at least one of the silane and oxide is supplied to the containment region so as to cause it to flow turbulently.

34. A method according to claim 28, further comprising the step of separating produced hydrogen, oxide and functionalised Silica from one another.

35. A method according to claim 34, wherein the produced hydrogen, oxide and functionalised Silica are separated using a batch process.
